(19) United States
(12) Patent Application Publication
(10) Pub. No.: US 2013/0174344 A1
(43) Pub. Date: Jul. 11, 2013

(54) COMPONENT WITH MULTIPLE LAYERS

(71) Applicants: Steve Klancnik, Lake Barrington, IL (US); Leona Wightman, Huntley, IL (US)

(72) Inventors: Steve Klancnik, Lake Barrington, IL (US); Leona Wightman, Huntley, IL (US)

(21) Appl. No.: 13/346,429

(22) Filed: Jan. 9, 2012

(51) Int. Cl. A47G 9/10; A47C 27/14; B32B 5/26; B32B 5/18; B32B 5/32; B32B 27/40

(52) U.S. Cl. 5/636; 428/316.6; 442/226; 442/374; 428/304.4; 428/221; 428/222; 442/223; 442/372; 5/690; 5/698

(57) ABSTRACT

Components are disclosed that include a first layer and a second layer affixed to the first layer or an optional third layer. At least one of the first layer and the second layer includes a gel foam.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

Mattresses with multiple layers are disclosed herein.

2. Description of the Background of the Invention

Manufacturers of mattresses have made significant improvements in mattress comfort in recent decades. One innovation that has contributed to the improvement in mattress comfort is the introduction of foams. A primary foam material used by manufacturers is polyurethane foam.

Foams have numerous characteristics, including density and firmness, that contribute to the “feel” of the mattress. Density refers to the amount of gas-containing cells within a foam matrix. Firmness refers to the rigidity of the matrix, such as polyurethane, itself. Therefore, by varying the density and firmness of a foam, one may provide a mattress having a different “feel.” Further, by combining layers of different types of foams, a multitude of different mattresses possessing a broad spectrum of “feel” may be produced. However, problems persist in foam-containing mattresses. For example, many manufacturers utilize foams that have a more closed-cell structure, which restricts air flow through the mattress resulting in poor heat dissipation or transfer away from an individual resting upon the mattress.

Another problem with current approaches to mattress manufacture relates to the effective support of an individual on the mattress. Many foams are not able to conform well to the curves of an individual's body and provide poor support by focusing the individual's weight on a couple of points on the foam rather than along the entire length of the foam adjacent to the individual's body. This is due to a phenomenon referred to as “bottoming out” where the individual's weight on the foam compacts the foam to a point where resilience is lost. Typical foams bottom out and exhibit a hard “feel” as they are compacted by the weight of an individual's body.

In light of the above, there exists a need for an improvement in the materials and methods used for manufacturing beds to provide greater comfort. Incorporation of new materials into mattresses that improve air flow and cooling through better heat dissipation is desirable. Moreover, the use of materials that simultaneously improve heat dissipation while providing better support would provide a marked improvement in the bedding industry.

### SUMMARY OF THE INVENTION

According to one aspect of the present disclosure, a component includes a first layer and a second layer affixed to the first layer or an optional third layer. At least one of the first layer and the second layer comprises a gel foam.

According to another aspect of the present disclosure, a bedding component includes a top portion and a middle portion having a foam core, wherein the middle portion is affixed to a bottom surface of the top surface with an adhesive. The bedding component further includes a bottom portion. At least one of the top portion, the foam core, and the bottom portion comprises a gel foam.

According to a further aspect of the present disclosure, a mattress includes a gel foam topper layer, a core layer disposed beneath the gel foam topper layer and having at least one of a foam core, a gel foam core, a latex core, an inner spring layer, or a layer of individually wrapped coils. The mattress further includes a fire-resistant layer affixed beneath a bottom surface of the core layer and a fire-resistant sock that encloses at least the core layer and the fire-resistant layer.

### BRIEF DESCRIPTION OF THE DRAWINGS

FIG. 1 is an exploded isometric view of a component according to one embodiment;

FIG. 2 is a top plan view of an adhesive application pattern that may be used in the affixation of layers within the components according to one embodiment;

FIG. 3 is a top plan view of an adhesive application pattern that may be used in the affixation of layers within the components according to a further embodiment;

FIG. 4 is a perspective view of a foam layer according to one embodiment;

FIG. 5 is a perspective view of a foam layer according to another embodiment;

FIG. 6. is an exploded isometric view of a component according to one embodiment;

FIG. 7. is an exploded isometric view of a component according to a further embodiment;

FIG. 8. is an exploded isometric view of a component according to another embodiment similar to FIG. 7;

FIG. 9. is an exploded isometric view of a component having a bilayer layer according to one embodiment;

FIG. 10. is an exploded isometric view of a component having a bilayer layer according to another embodiment;

FIG. 11. is an exploded isometric view of a component having multiple layers; and

FIG. 12. is an isometric view of a component according to one embodiment enclosed within a fire-resistant sock.

### DETAILED DESCRIPTION

The present disclosure relates to layered components, such as a bedding component, including mattresses, cushions, pillows, mattress supports, such as box springs, pads, mats, and the like. Components of the present disclosure may be constructed of multiple layers as described hereinbelow to provide a desired effect, such as a firm feel, a heat dissipating feel, a soft feel, and the like, to a user resting on a top surface thereof. In a preferred embodiment, the layered components include a gel foam placed therein or thereon.

The contemplated components may be part of a conventional item of furniture, such as a bed equipped with a bed frame. In this scenario, the component may be a mattress that is placed upon the bed frame, perhaps atop of a box spring or other mattress support. As an alternative, the component may form an integral part of an item of furniture. For example, the component may be in the form of a padded sleeping surface of a foldable cot, wherein the sleeping surface incorporates one or more structural components of a support frame of the cot. In this way, the sleeping surface is affixed to the support frame of the cot. In other examples, the component may be a cushion of a chair or a couch, a throw pillow, a pet pillow, a portion of a car seat, or any other padded surface.

Components may be of any desired size according to the intended use. In the context of mattresses, a mattress may have a length of about 73 to about 82 inches and a width of about 37 to about 75 inches. However, a mattress may be shorter or longer. Indeed, many mattresses may be manufactured to conform to standard size conventions, such as, a crib mattress size, a twin bed size, a twin XL size, a full bed size, a full XL size, a queen bed size, a king bed size, and a California king size.

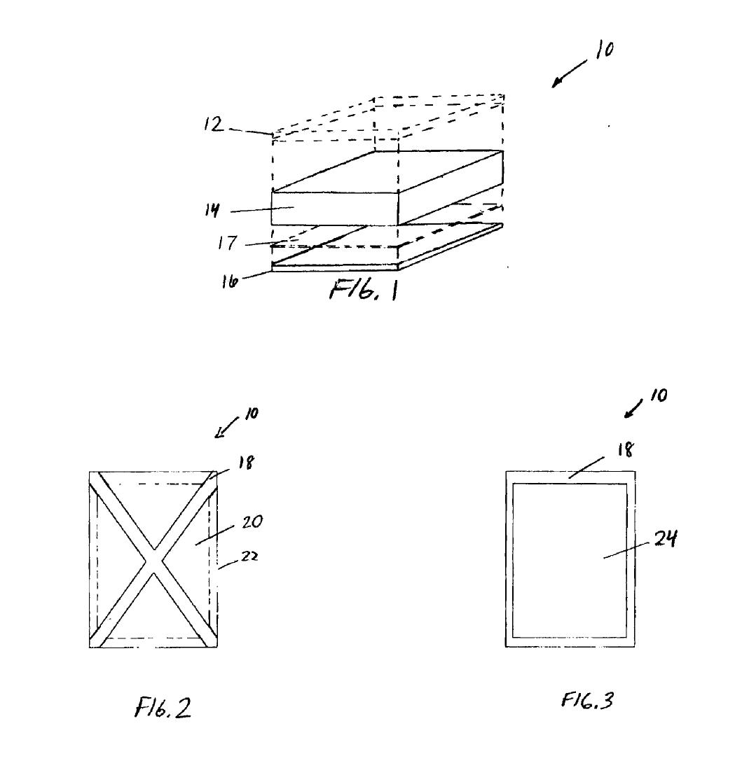

In one embodiment depicted in FIG. 1, a contemplated component comprises a component 10 that includes an optional top portion 12, a middle portion 14, a bottom portion 16, and an optional intermediate portion 17 disposed between the middle and bottom portion. The top portion 12 and intermediate portion 17 may each be comprised of x+m layers, wherein x=0, and m=0-infinity, and wherein each of x+m layers is affixed to any adjacent layer on a top surface and/or a bottom surface thereof. For example, top portion 12 or intermediate portion 17 may include 0 layers, or 1-6 layers, or 2-8 layers, or 3-12 layers, or 4-20 layers. The middle portion 14 and bottom portion 16 may each be comprised of x+n layers, wherein x=0, and n=1-infinity, and wherein each of x+n layers is affixed to any adjacent layer on a top surface and/or a bottom surface thereof. For example, middle portion 14 or bottom portion 16 may include 1-6 layers, or 2-8 layers, or 3-12 layers, or 4-20 layers. However, the sum of all the layers of the component is greater than or equal to 2, i.e., 2(x+m)+2(x+n)≦2, and more preferably the sum of all layers is between 2 and 20. The layers disclosed herein may be arranged, for example, stacked, in any order relative to one another.

Layers may be affixed by any suitable means known in the art. Layers may be sprayed-on, injection molded, extruded, coextruded, laminated, and the like. In several preferred embodiments, layers may be stapled, tacked, welded, laminated, mechanically affixed via friction or interference fit, adhered via an adhesive, a glue, a cement, or other material with adhesive properties, stitched, affixed via hook and loop fastener, a zipper, a Dennison-style tag, snaps, and/or other reversible means.

In one embodiment, the layers of FIG. 1 may be adhered together with an adhesive or other suitable means. When an adhesive is used, top portion 12 layers and middle portion 14 layers may be adhered together by applying an adhesive in a pattern as shown in FIG. 2, where the adhesive 18 forms an “X” pattern on a bottom surface 20 of, for example, a top portion 12 layer. In another embodiment, an additional peripheral pattern of adhesive 22 may be added to the “X” pattern to provide a greater bond between layers. It is further contemplated that any of a top or bottom surface of layers from any of the top, middle, intermediate, or bottom portions may be affixed in this manner and have an adhesive applied to either the top or bottom surfaces or both.

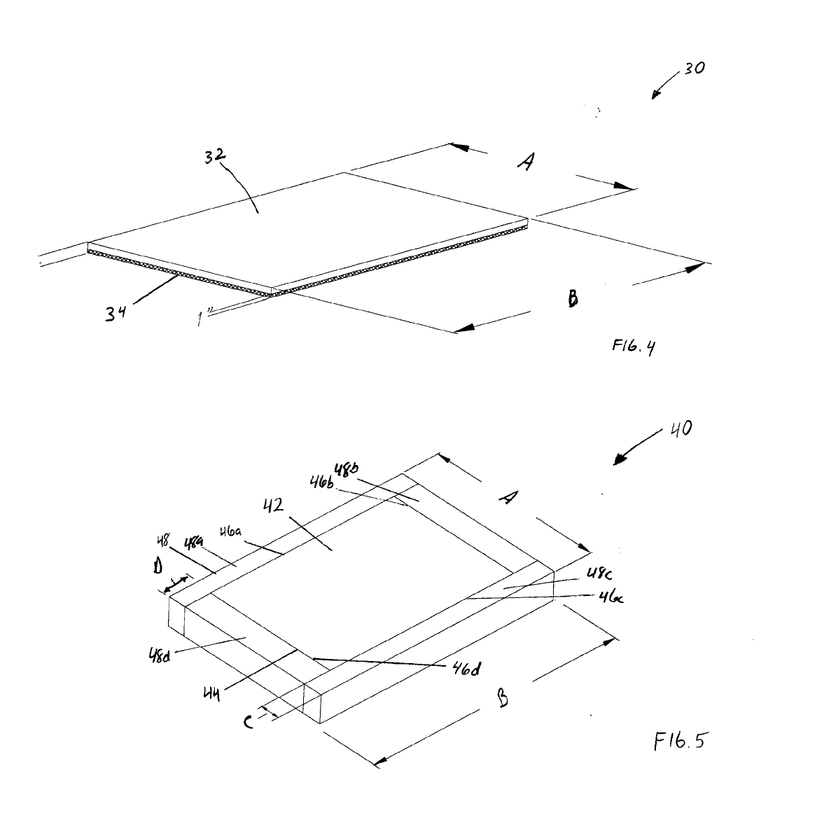

An alternate adhesive application pattern may be used to adhere a fire-resistant layer directly to a bottom surface of the middle portion 14, such as a foam core, or intermediate portion 17, of the component. As is seen in FIG. 3, the adhesive 18 is applied to an entire periphery of a bottom surface 24 of the portion. In this way, the fire-resistant layer is ensured to completely cover the bottom surface 24 of the foam core. In one embodiment, the bottom portion 16 includes the fire-resistant layer.

Component layers may be of any thickness. For example, in several preferred embodiments, the component layer is less than or about ½ inch, less than or about 1 inch, less than or about 2 inches, less than or about 3 inches, less than or about 4 inches, less than or about 5 inches, less than or about 6 inches, less than or about 8 inches, or less than or about 12 inches, and all thicknesses in between. Component layers may also be of varying widths and lengths that are not necessarily tied to the size of the component. For example, a mattress may include a first layer with a first width and a second layer with a second width, where the first width is wider or narrower than the second width. When a layer is wider than the component, it may be folded in upon itself or folded upwardly or downwardly along the side of the component to form a portion of a sidewall of the component. Similar variability with respect to layer length is also possible.

Layers may include a fabric, a natural fiber, a synthetic fiber, a ticking layer, a quilt layer, a thread layer, a film, a foam, a gel, a gel foam, a woven layer, a nonwoven layer, a fire-resistant layer, a non-skid layer, and combinations thereof. A component core layer may be any mattress core construction including a foam core, a gel foam core, latex core, an inner spring layer, or a layer of individually wrapped coils. For example, fire-resistant layers contemplated for use herein include PFG880 Precision Fabrics Group (Greensborough, N.C.) and Tietex C243 (Tietex International, Ltd., Spartanburg, S.C.). Additional fire resistant fabrics may include materials comprising fire-resistant polyesters and/or fire-resistant rayon, and the like. Further, additional materials that may be used in the construction of the components contemplated herein include those disclosed in Attorney Docket Nos. 135845.01311, entitled “Bedding Component With Fire-resistant Laminate,” and 135845.01312, entitled “Method for Providing a Fire-resistant Component,” each filed on the same date as the present disclosure (numbers to be assigned).

In another embodiment, a layer may further include an adhesive, such as a hot melt, water-based or pressure sensitive adhesive. Adhesives that may be used in the present disclosure include any adherent materials or fasteners known in the art. Specific examples of adhesives include hot melt, water-based, and pressure-sensitive adhesives, fire-resistant adhesives, and mixtures thereof. Hot melt adhesives that may be used include those available from Henkel (Rocky Hill, Conn.) and UPACO adhesives available from Worthen Industries (Nashua, N.H.). Water-based adhesives that may be used include water-based adhesives under the SIMALFA brand available from Alfa Adhesives, Inc. (Hawthorne, N.J.). Further, a layer may further include a silica, a metallic layer, a plastic, such as an acrylic, a modacrylic, a polyolefin, a latex, a polyurethane, and combinations and/or blends thereof. In addition, a layer may further include biocides, preservatives, odor blocking agents, scents, pigments, dyes, stain guards, antistatic agents, antisoiling agents, water-proofing agents, moisture wicking agents, and the like, as are known in the art.

One particular material contemplated herein is foam, such as a polyurethane or latex-containing foam. Foams contemplated herein may vary by density, firmness, as may be measured by indentation force deflection (IFD) or other suitable metrics, and thickness, among other characteristics. One example of a foam that may be used is KOOLCOMFORT foam. Additional foams contemplated are available from Advanced Urethane Technologies (West Chicago, Ill.). The characteristics of a foam layer may be chosen based on whether the layer is to be placed within the top portion 12, the middle portion 14, the bottom portion 16, or the intermediate portion 17 of the component (see FIG. 1). A foam to be used in the top portion 12 of a component, such as a mattress, may be less firm to provide a more comfortable feel than a foam used in the middle portion 14, which provides a relatively more rigid support for the top portion. Foams may have a density of about 1 to about 5 lbs/ft³, or about 2 to about 4 lbs/ft³. With respect to firmness, contemplated foams used herein may have an IFD of between about 1 to about 100 lbs, or about 2 to about 60 lbs, or about 6 to about 36 lbs, or about 12 to about 52 lbs, or about 20 to about 80 lbs. Foam layers may be monolithic or formed from multiple pieces of a single foam material or of different foam materials affixed to one another, as described herein.

Another particular material contemplated herein is a gel foam. Gels include a solid three-dimensional molecular network that comprise a substantially cross-linked system of particles distributed in a gelatinous matrix of any form, shape or size which exhibit no or substantially no flow when at steady-state. Discrete gel particles or articles can have physical properties ranging from soft-to-hard and weak-to-tough. Gels have defined and sustainable shapes supported by a continuous three-dimensional network of cross-linked particles. Gel foams are a binary system of dissimilar materials in which the continuous phase may be a polyurethane foam or a similar suitable material, and one or more gels is infused or integrated into the continuous phase as discrete particles, beads or other shapes thereby modifying the support factor, thermal capacitance, and/or thermal conductance characteristics. In this way, heat dissipation capacity and additional comfort may be incorporated into a component of the present disclosure.

Contemplated gel foams may or may not be memory foams. Additional materials contemplated include memory foams, which may be a memory gel foam and/or a latex gel foam. A memory foam exhibits a slow return to its original form once compacted by a weight. Further, memory foams are activated by temperature of user's body, in that, memory foams soften where they come in contact with user's body and thereby more easily conform to the user's body curves. One type of a memory foam is a slow response latex foam.

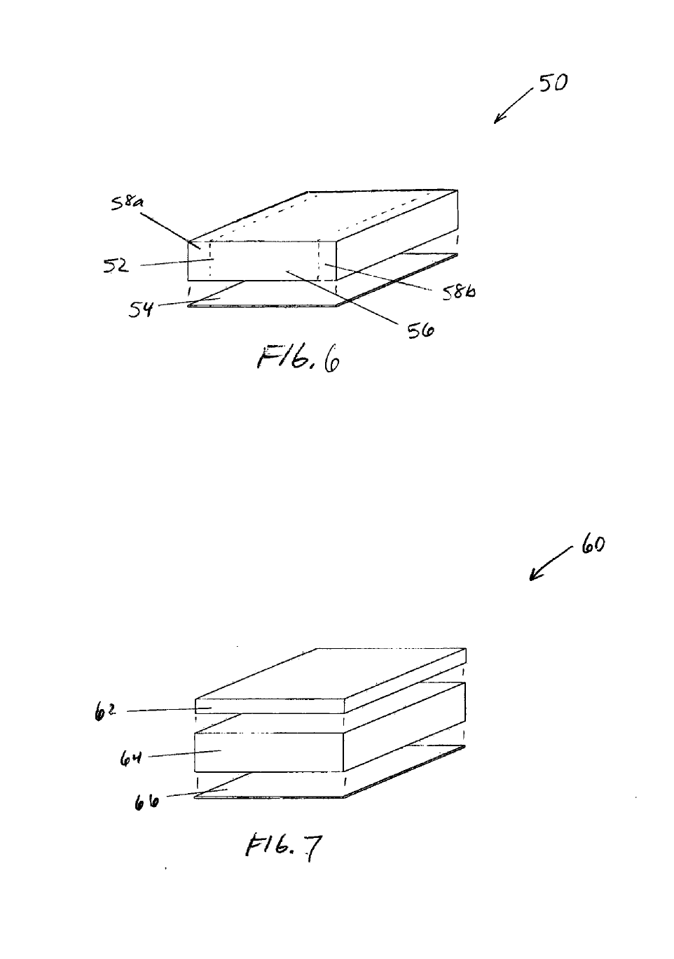

Layers, such as foam layers, may be monolithic or may include multiple portions of the same or different materials affixed together, as shown in FIGS. 4 and 5. In one embodiment, FIG. 4 depicts a foam layer 30 with a top layer 32 affixed to a top surface of a bottom layer 34. The top layer 32 and bottom layer 34 may have the same thickness or have a different thickness relative to the other layer, as desired. Top layer 32 and bottom layer 34 may also be made of the same or a different foam material that may differ in density and/or firmness. In this way, the bottom layer 34 by having a greater density and/or firmness may provide additional structural support to the foam layer 30. For example, the top layer 32 may have a density of about 3 to about 3.4 lbs/ft³ and an IFD of about 6.5 to about 8.5 lbs, while the bottom layer 34 has a density of about 1.2 lbs/ft³ to about 1.35 lbs/ft³ and an IFD of about 15 to about 20 lbs. Additional variations in density and/or firmness are contemplated including where the top layer 32 has a greater firmness compared to the bottom layer 34. As an additional alternative to the embodiment shown in FIG. 4, either one of the top layer 32 or the bottom layer 34 may have a different dimension in width A and/or in length B relative to the other.

FIG. 5 depicts a layer 40, such as a foam layer, that includes an inner portion 42 affixed along a peripheral side surface 44 to side surfaces 46a-d of an outer portion 48. In one particular embodiment, the outer portion 48 comprises discrete outer portions 48a-d. For purposes of affixation, the inner portion 42 and outer portions 48a-d may be affixed as any other layer herein. In the embodiment shown in FIG. 5, the outer portion 48 surrounds the inner portion 42 and has a width C along length B of the layer 40 and a width D along width A of the layer. The widths C and D may be the same or may differ from one another. Accordingly, widths C and D may each independently be about ½ inch to about 10 inches, or about 1 inch to about 8 inches, or about 2 inches to about 6 inches.

In addition to the embodiment depicted in FIG. 5, alternate embodiments are contemplated where fewer outer portions border the inner portion 42, for example, along 1, 2 or 3 sides. Further, in still other embodiments, the outer portions 48a-d may comprise a unitary structure or more or less than the four previously mentioned discrete portions. Moreover, the inner portion 42 and outer portions 48a-d may be made of the same or a different material and may have the same or different density and/or firmness values, in the case of a foam material. In this way, the outer portions 48a-d may provide additional structural properties to the layer 40. For example, in the context of a foam, the inner portion 42 may have a density of about 1.5 lbs/ft³ and an IFD of about 28-33 lbs, while the outer portion 48a-d has a density of about 1.45 lbs/ft³ and an IFD of about 40-45 lbs. Additional variations in density and/or firmness are contemplated including where the inner portion 42 has a greater firmness compared to the outer portion 48a-d.

As another alternative, the attributes of the embodiments depicted in FIGS. 4 and 5 may be combined. For example, a foam layer may have inner and outer portions analogous to inner portion 42 and outer portions 48a-d of FIG. 5, of which one or both of the portions, 42 and 48a-d may have a top layer and a bottom layer analogous to the top layer 32 and the bottom layer 34 of FIG. 4. Each of the aforementioned layers and portions may be the same material, different materials, or mixtures thereof.

In a further embodiment, the lines 44 and 46a-d may demarcate different materials included in the layer 40, such as different foams. These lines of demarcation may indicate affixation points of separate materials or gradient changes from one material to another of a single portion.

A further layer contemplated includes a fire-resistant material that is laminated to a bottom surface of the component. Typically, the fire-resistant laminate is adhered to a bottom surface of a foam layer. In the context of a mattress, the fire-resistant layer may be a non-skid material, which helps prevent the mattress from sliding when placed on top of a mattress support, such as a box spring. One example of a non-skid material is a velour, though additional materials are contemplated. Fire-resistant materials useful as laminates include fabrics, spun-bonded materials, stitch-bonded materials, woven materials, nonwoven materials, films, and other flexible and/or stretchable materials that are made of inherently fire-resistant threads or that have been treated with or constructed to include a fire-resistant material or both. In one particular embodiment, the fire-resistant material may include PFG880 and PFG 6009-5006 barrier filler cloth, which has a basis weight of about 4.5 to about 6.1 oz/yd², available from Precision Fabrics Group (Greensborough, N.C.), and Tietex C243, which has a basis weight of about 5.0 oz/yd² and is available from Tietex International, Ltd. (Spartanburg, S.C.).

The fire-resistant layer provides additional rigidity to the edges and corners of the bottom surface of a foam layer, which enables the component to be better tailored within a fabric cover when the fire-resistant laminate is at the bottom surface of the component. In addition, the fire-resistant layer adds to the durability of the bottom surface of the component against normal wear and tear. Components constructed with a fire-resistant laminate bottom layer may be used in the assembly of components, such as mattresses, and thereby enable the production of mattresses with improved fire-resistance compared to conventional mattresses.

Another type of layer considered includes a sock layer that completely surrounds one or more layers. For example, the sock layer may be made of a fire-resistant material and therefore help protect layers disposed therein from open flame. One fire-resistant sock material that may be used is Springs Creative fire-resistant sock available from Springs Creative (Rock Hill, S.C.), which is made of about 61% modacrylic and about 39% silica (fiberglass), has a density of about 7.0 oz/yd², and a thickness of about 0.02 inches. While the fire-resistant laminates of the present disclosure may be rigid materials, fire-resistant socks are typically “transparent” to the feel of the component. Therefore, in the context of a mattress, the fire-resistant sock is not readily noticeable by an individual resting thereon. Fire-resistant socks of this type may confer fire-resistance to materials enclosed therein when the fire-resistant sock is closed by an adhesive and/or a thread or yarn including fire-resistant threads or yarns. Specific examples of fire-resistant threads include Tex 50 para-amid thread and similar threads, available from Saunders (Gastonia, N.C.) and 12/1 para-amid yarn and similar yarns available from Pharr Yarns (McAdenville, N.C.).

Fire-resistant laminates and fire-resistant socks provide advantages over conventional components, such as mattresses. For example, fire-resistant laminates and socks provide char barriers that retard combustion of the component when contacted with an open flame. Further, the fire-resistant laminates and socks control the flow of gases and molten foam, such as polyurethane, from components exposed to open flame. By controlling the flow of flammable material from a component when exposed to flame, fire-resistant laminates and socks effectively limit the amount of fuel that could contribute to a fire.

FIG. 6 depicts another embodiment of a component 50 that includes a gel foam core 52 and a fire-resistant layer 54. Here, the foam core 52 may be monolithic and have a thickness of less than or about 12 inches. As an alternative, the foam core 52 may have an inner portion 56 with a density of about 1.5 lbs/ft³ and an IFD of about 28 to about 33 lbs and outer portions 58a,b, which have a width of about 4 inches, a density of about 1.45 lbs/ft³ and an IFD of about 40 to about 45 lbs. The foam core 52 and fire-resistant layer 54 may be affixed as described herein.

FIG. 7 illustrates another contemplated component 60 that includes a gel foam topper layer 62 affixed to a top surface of a foam core 64, which is affixed to another layer 66. In this embodiment, the gel foam topper layer 62 may have a density of about 3.75 lbs/ft³ to about 4.1 lbs/ft³ and an IFD of about 8.5 to about 10.5 lbs. Here, the addition of the gel foam topper layer 62 may serve to soften the feel of the component 60. Further, the gel foam topper layer 62 may also help to dissipate or disperse heat from an individual resting on the component 60.

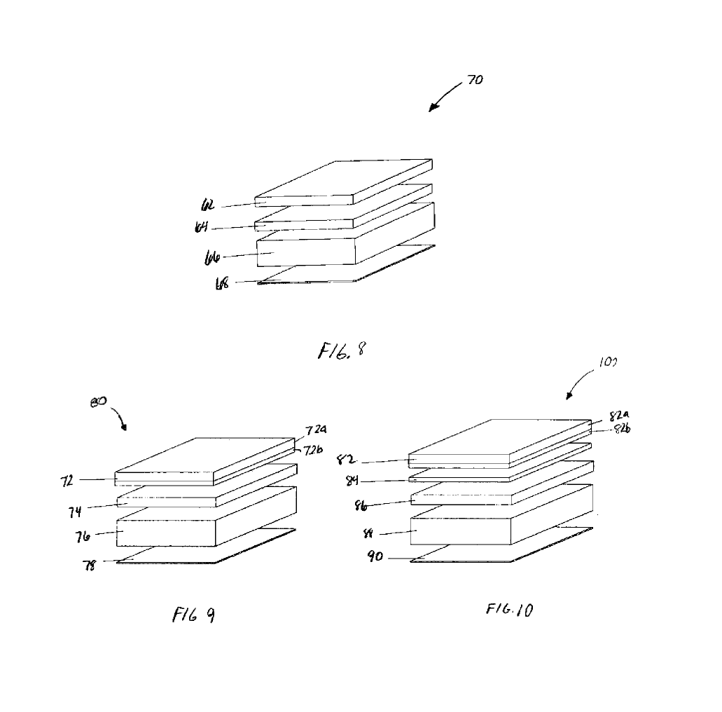

Another embodiment is depicted in FIG. 8, which includes a component 70 that differs from the component 60 of FIG. 7 by the addition below the gel foam topper layer 62 of a second foam layer 64 that is affixed to a top surface of a foam core 66. The foam core 66 is affixed to the top surface of another layer 68, which may be a fire-resistant layer or another foam layer. The second foam layer 64 may have a density of about 1.0 to about 2.0 lbs/ft³ and an IFD of about 47.5 to about 52.5 lbs. The addition of the second foam layer 64 provides increased firmness to the gel foam topper layer 62.

In a further embodiment shown in FIG. 9, a component 80 includes a bilayer gel foam topper 72 affixed to a top surface of a gel foam layer 74. The gel foam layer 74 is, in turn, affixed atop a foam core 76 with a fire-resistant layer 78 affixed to a bottom surface thereof. The bilayer gel foam topper 72 has a top layer 72a made of a heat dissipating gel foam that has a density of about 2.95 to about 3.35 lbs/ft³ and an IFD of about 6.5 to about 8.5 lbs. The bilayer foam topper 72 further includes a bottom layer 72b affixed to the top layer 72a that has a density of about 1.2 to about 1.35 lbs/ft³ and an IFD of about 15 to about 20 lbs. The heat dissipating topper layer 72a in combination with the gel foam layer 74, which also has heat dissipating properties, provides for greater heat dissipation for greater comfort to an individual resting on the component 80.

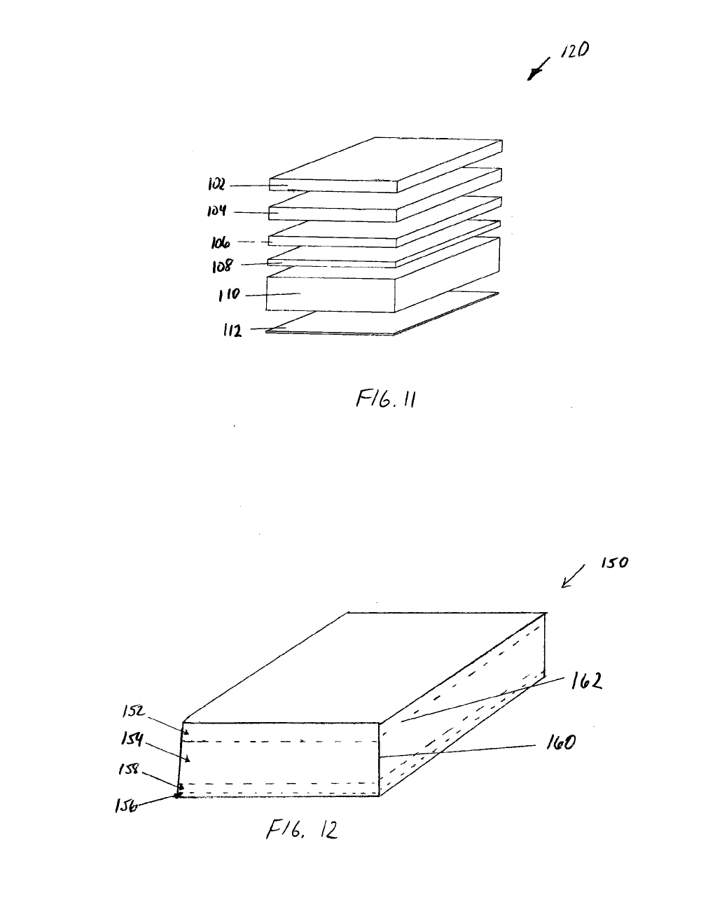

FIG. 10 depicts a variation of the component 80 of FIG. 9, in that, the component 100 includes a bilayer gel foam topper 82, with a top layer 82a and a bottom layer 82b, a slow response latex foam layer 84, a gel foam topper layer 86, a foam core 88, and a fire-resistant layer 90 affixed together as shown. The slow response latex foam layer 84 may be made of 100% synthetic latex and have a density of about 5 lbs/ft³ and a thickness of about 1 inch.

A further embodiment, depicted in FIG. 11, contemplates a component 120 that includes a gel foam topper 102, a second foam layer 104, a latex gel layer 106, a high IFD foam layer 108, a foam core 110, and a fire-resistant layer 112. The latex gel layer 106 may be a Talalay process latex containing synthetic and natural latex comprising about 18% gel material by weight and having a density of about 4.0 to about 4.8 lbs/ft³. The high IFD foam layer 108 may have a density of about 1.0 to about 2.0 lbs/ft³ and an IFD of about 47.5 to about 52.5 lbs.

In another embodiment shown in FIG. 12, a component 150 includes a top portion 152 comprising a gel foam layer, a middle portion 154, a fire-resistant laminate 156, and an optional intermediate portion 158. A fire-resistant sock 160 is disposed around the top 152, middle 154, bottom 156, and optional intermediate portions 158. In an alternative embodiment, only the middle 154, bottom 156, and optional intermediate portions 158 are disposed within the fire-resistant sock 160, wherein the top portion 152 comprising the gel foam layer rests on an upper surface 162 of the fire-resistant sock 160.

### INDUSTRIAL APPLICATION

The components disclosed herein provide improvements in comfort for mattresses and other cushioned furniture. The disclosure has been presented in an illustrative manner in order to enable a person of ordinary skill in the art to make and use the disclosure, and the terminology used is intended to be in the nature of description rather than of limitation. It is understood that the disclosure may be practiced in ways other than as specifically disclosed, and that all modifications, equivalents, and variations of the present disclosure, which are possible in light of the above teachings and ascertainable to a person of ordinary skill in the art, are specifically included within the scope of the claims. All patents and patent applications disclosed herein are incorporated by reference herein, in their entireties.

What is claimed is:

1. A component, comprising:
a first layer; and
a second layer affixed to the first layer or an optional third layer,
wherein at least one of the first layer and the second layer comprises a gel foam.

2. The component of claim 1 further comprising the third layer.

3. The component of claim 2, where the first layer comprises the gel foam.

4. The component of claim 1, wherein the gel foam comprises a continuous matrix of polyurethane foam.

5. The component of claim 3, wherein the second layer is affixed to a top surface of the third layer.

6. The component of claim 3, wherein the second layer and the third layer each comprises at least one of a fabric, a natural fiber, a synthetic fiber, a ticking layer, a quilt layer, a thread layer, a film, a foam, a gel, a gel foam, spun-bonded material, a stitch-bonded material, a woven layer, a nonwoven layer, a fire-resistant layer, a non-skid layer, and combinations thereof.

7. The component of claim 6, wherein the second layer comprises an inner portion and an outer portion.

8. The component of claim 3, wherein the second layer comprises at least one of a foam core, a gel foam core, a latex core, an inner spring layer, or a layer of individually wrapped coils.

9. The component of claim 3, wherein the first layer further comprises a top layer and a bottom layer, wherein the top layer and the bottom layer each comprise a different material.

10. A bedding component, comprising:
a top portion;
a middle portion comprising a foam core, wherein the middle portion is affixed to a bottom surface of the top portion with an adhesive; and
a bottom portion,
wherein at least one of the top portion, the foam core, and the bottom portion comprises a gel foam.

11. The bedding component of claim 10, wherein the top portion comprises a fabric, a natural fiber, a synthetic fiber, a ticking layer, a quilt layer, a thread layer, a film, a foam, a gel, a gel foam, a woven layer, a nonwoven layer, a fire-resistant layer, a non-skid layer, an adhesive, fiberglass, a metallic layer, a plastic, a latex, a polyurethane, or a combination thereof.

12. The bedding component of claim 10, wherein the bottom portion comprises a fire-resistant layer.

13. The bedding component of claim 12, wherein the fire-resistant layer is selected from the group consisting of PFG880 and Tietex C243.

14. The bedding component of claim 10, wherein the foam core has a density of about 1 to about 5 lbs/ft³.

15. The bedding component of claim 14, wherein the foam core has an IFD of between about 1 and about 100 lbs.

16. The bedding component of claim 10, wherein the bedding component comprises a mattress, a cushion, a pillow, a pad, or a mat.

17. The bedding component of claim 16, wherein the bedding component comprises a mattress.

18. A mattress, comprising:
a gel foam topper layer;
a core layer disposed beneath the gel foam topper layer and comprising at least one of a foam core, a gel foam core, a latex core, an inner spring layer, or a layer of individually wrapped coils;
a fire-resistant layer affixed beneath a bottom surface of the core layer; and
a fire-resistant sock that encloses at least the core layer and the fire-resistant layer.

19. The mattress of claim 18, wherein the mattress has a size selected from the group consisting of a crib mattress size, a twin bed size, a twin XL size, a full bed size, a full XL size, a queen bed size, a king bed size, and a California king size.

20. The mattress of claim 18, further comprising at least one of a biocide, a preservative, an odor blocking agent, a scent, a pigment, a dye, a stain guard, an antistatic agent, an antisoiling agent, a water-proofing agent, a moisture wicking agent, or a mixture thereof.
